(19) United States
(12) Patent Application Publication
(10) Pub. No.: US 2010/0205486 A1
(43) Pub. Date: Aug. 12, 2010

(54) System and method of error reporting

(75) Inventors: Chaucer Chiu, Taipei (TW); Hui Wang, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/320,844

(22) Filed: Feb. 6, 2009

(51) Int. Cl. G06F 11/07

(52) U.S. Cl. 714/48; 714/E11.025

(57) ABSTRACT

A system of error reporting and the method thereof are provided. A user end sends an error message to a server. The server uses the error message to check historical data and find out how to process the error message. This solves the problem of inconvenient notification channel when an application program on the user end discovers an error. This is helpful to increase the convenience and thus enhance the efficiency in sending error reports.

### BACKGROUND OF THE INVENTION

1. Field of Invention

The invention relates to an error reporting system and the method thereof. In particular, the invention pertains to a system that implements error reporting for application programs via a network and the method thereof.

2. Related Art

With rapid development in information technology and progress in the Internet, computers have become an indispensable part of our life. Computer application programs are also very important for users in word processing, browsing data, and inquiring information.

Since data involved in the usual application program are huge and complicated, software developers inevitably make mistakes in the code, such as data missing or errors. These errors are often discovered by the users during their uses. Most users simply ignore such errors. Some users may file complaints by calling the customer services. One reason for the user not to report the error is there is no appropriate error report channel. Another reason is the error reporting system provided in the software is difficult to use. For example, the user may need to connect via a network to an error reporting web page, enter user information, a detailed error message, and detailed correction information. The tedious and time-consuming operation impedes error reporting. As a result, the software errors are likely to stay there and the users are less willing to use it.

In summary, the prior art long has the problem of inconvenient error reporting channel when the user discovers an error while running an application program. It is therefore imperative to provide an improved technical means to solve this problem.

### SUMMARY OF THE INVENTION

In view of the foregoing, the invention discloses an error reporting system that implements error reporting for an application program via a network. It includes at least a user end and a server end. The user end runs the application program that transmits an error message through the triggering of a reporting element. The error message includes user information and an error block location in the application program. The server end includes a receiving module, a determining module, a storage module, and a replying module. The receiving module receives the error message sent from the user end. The determining module uses the error block location of the error message to find a corresponding data index, checks historical data according to the data index, and determines whether the error message is allowed. When the historical data do not contain the data index and the error message is allowed, the storage module saves the error block location of the error message into the historical data. The replying module returns a replying message when the data index already exists in the historical data and the error message is not allowed.

The disclosed error reporting method is used to report errors of an application program via a network. The method includes the steps of: running an application program on a user end and, through the triggering of a reporting element, transmitting an error message including user information and an error block location in the application program; receiving at a server end the error message sent from the user end, using the error block location of the error message to find a corresponding data index on the server end, determining whether the error message is allowed by checking historical data with the data index; saving the error block location of the error message into the historical data when the data index does not exist therein and the server end allows the error message; and returning a replying message when the data index already exists in the historical data and the server end does not allow the error message.

The system and method disclosed above are different from the prior art in that the invention first sends the error message from the user end to the server end. The server end then looks up the historical data according to the error message to determine whether the error message has been reported before. If it has not been reported, the error message is stored in the historical data. If it has been reported, a replying message is returned.

Using the above-mentioned technical means, the invention can increase the convenience in error reporting as well as the efficiency in processing the error reports.

### BRIEF DESCRIPTION OF THE DRAWINGS

The invention will become more fully understood from the detailed description given herein below illustration only, and thus is not limitative of the present invention, and wherein:

FIGS. 1 and 2 are block diagrams of the disclosed error reporting system;

FIG. 3 is a flowchart of the disclosed error reporting method; and

FIGS. 4 to 1 show steps in an embodiment of the disclosed error reporting system.

### DETAILED DESCRIPTION OF THE INVENTION

The present invention will be apparent from the following detailed description, which proceeds with reference to the accompanying drawings, wherein the same references relate to the same elements.

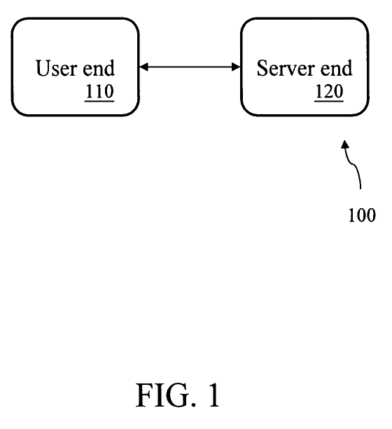

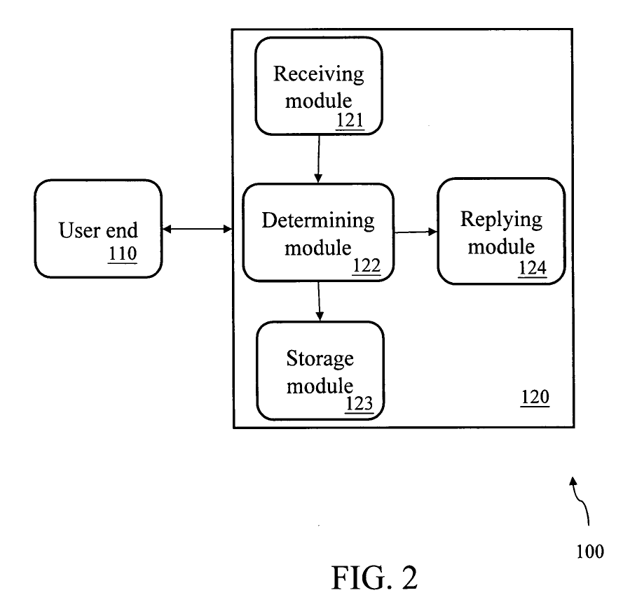

Before describing embodiments of the invention, please refer to accompanying figures for the explanations of the disclosed error reporting system and method. FIGS. 1 and 2 are block diagrams of the disclosed error reporting system 100. It includes: a user end 110 and a server end 120.

The user end 110 runs an application program and, through the trigger of a reporting element, sends an error message to the server end 120. The error message includes user information and error block location in the application program. That is, when running an application program on the user end 110 and an error occurs, the user end 110 triggers the reporting element in the application program and sends the error message via a network to the server end 120. It should be noted that the user information contained in the error message refers to the account name of the user and the serial number of the application program. The error message further includes version information and update information of the application program.

Besides, the error block location in the application program is obtained by using a mouse cursor to enclose the error range in the application at the user end 110. That is, when the user end 110 discovers an error in the application program, the user uses the mouse cursor to enclose the error range in the application program, obtaining the error block location thereof. Afterwards, the reporting element is triggered.

The server end 120 includes: a receiving module 121, a determining module 122, a storage module 123, and a replying module 124. The receiving module 121 receives the error message sent form the user end 110. That is, when the user end 110 sends the error message via the network to the server end 120, the receiving module 121 of the server end 120 receives the error message and obtains the user information and the error block location in the application program contained therein.

The determining module 122 uses the error block location in the error message received by the receiving module 121 to find a corresponding data index. The data index is then used to check the historical data, determining whether the error message is allowed. It should be noted that the determining module 122 stores the correspondence relation between the error block location and the data index. That is, different error block locations in the error message have their corresponding data indices. Therefore, the determining module 122 can use the error block location in the error message to find the corresponding data index. Afterwards, the data index is used to check the historical data, thereby determining whether the error message is allowed.

The historical data record the reported error block locations and their corresponding data indices. Therefore, the determining module 122 uses the data index to search the historical data and determines whether the data index already exists in the historical data. This mechanism determines whether the error block location in the error message has already been reported. If the data index is determined by the determining module 122 not to exist in the historical data, it means that the error block location in the error message has not been reported yet. The determining module 122 then allows the error message. On the other hand, if the determining module 122 determines that the data index already exists in the historical data, it means that the error block location in the error message has been reported. The determining module 122 thus does not allow the error message. The purpose is to avoid repeated reports of the same error block location.

When the data index does not exist in the historical data and the error message is allowed, the storage module 123 saves the error block location of the error message into the historical data. That is, when the determining module 122 determines that the data index does not exist in the historical data and the error message is allowed, the storage module 123 saves the error block location of the error message into the historical data. This means that the error block location changes from unreported to reported. The purpose of saving is to save the reported error block location for future references.

The replying module 124 returns a replying message when the data index already exists in the historical data and the error message is not allowed. That is, when the determining module 122 determines that the data index already exists in the historical data and the error message is not allowed, the replying module 124 returns a replying message to the user end 110. The purpose of returning a replying message is to notify the user end 110 about the fact that the error block location in the error message has been reported.

Through the operation of the above-mentioned error reporting system, the user end sends the error message to the server end. The server end refers to the historical data using the error message to determine whether the error message has been reported. If not, the error message is stored in the historical data. Otherwise, a replying message is returned. This solves the inconvenience in reporting errors of an application program.

The following embodiment is used to explain, but not restrict, the spirit of the invention. Any person skilled in the art can readily make modifications of the embodiment without leaving the scope of the invention.

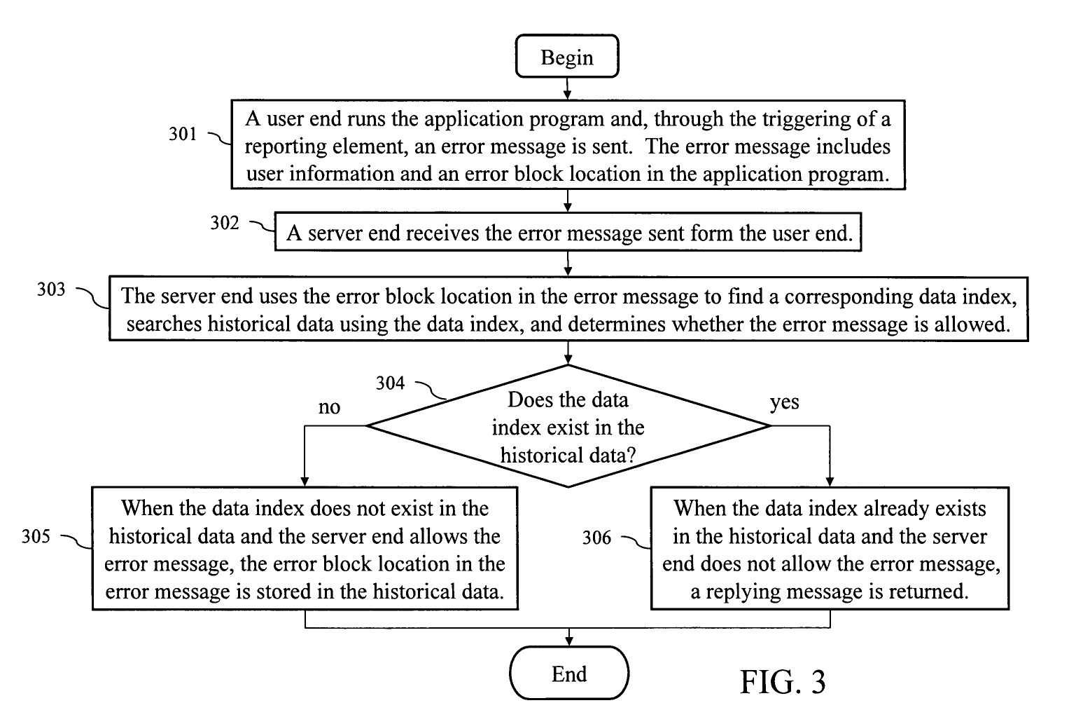

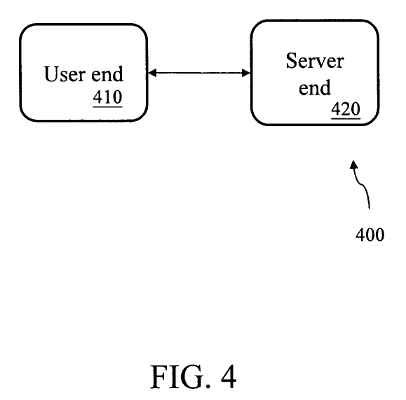

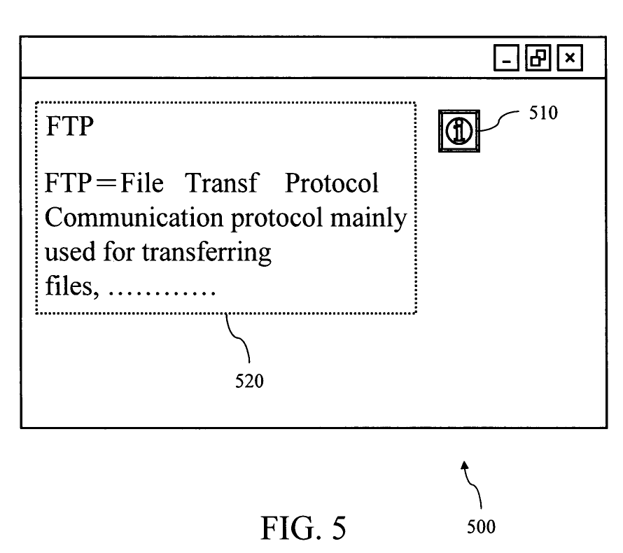

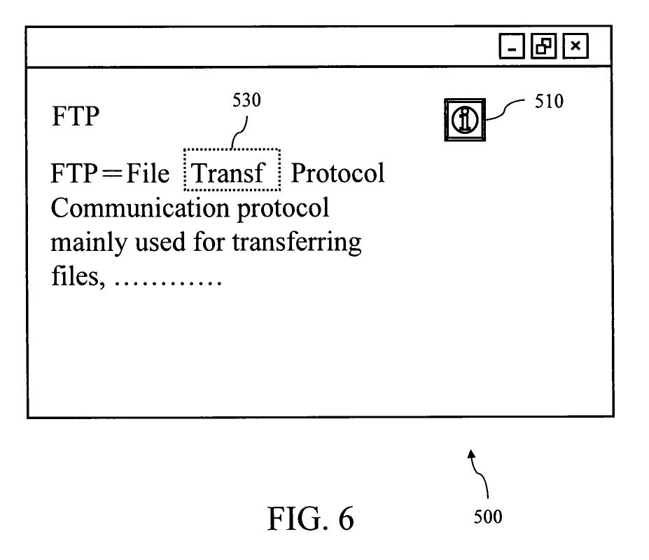

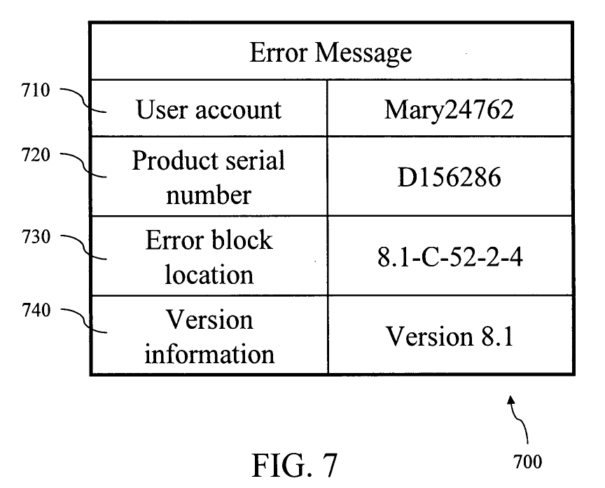

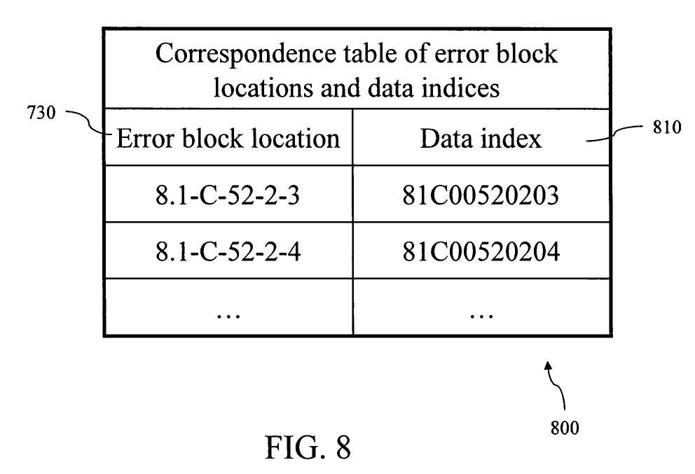

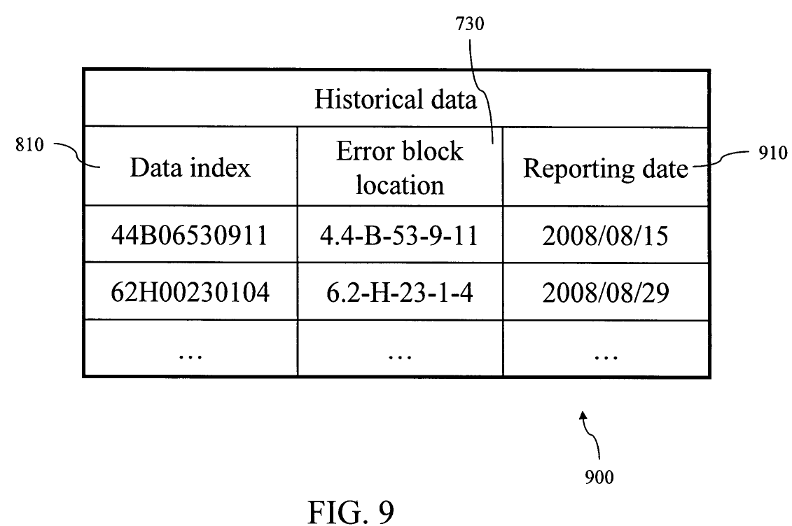

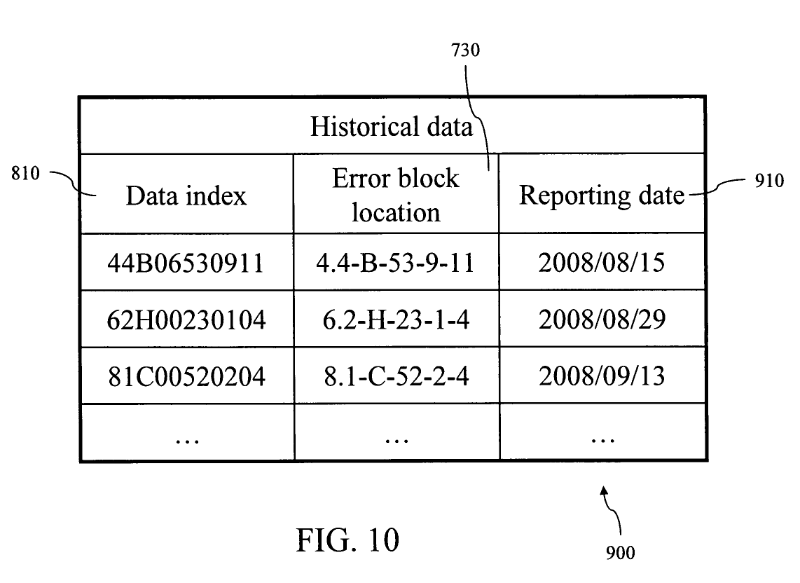

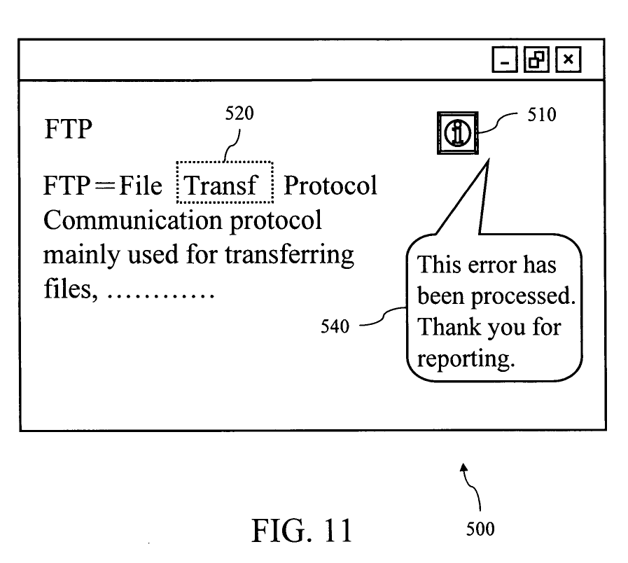

FIG. 3 is a flowchart of the disclosed error reporting method. FIGS. 4 to 11 show steps in the embodiment. Therefore, please refer to FIGS. 3 through 11 for the explanation of the embodiment.

In this embodiment, the application program is a real-time dictionary as an example. A user can use the search service thereof. When the user discovers that some content in the real-time dictionary has a mistake, he or she can use the disclosed error reporting system to notify the server of the real-time dictionary.

Please first refer to FIG. 4. The error reporting system 400 of the real-time dictionary includes a user end 410 and a server end 420. The user runs the real-time dictionary at the user end 410 for searching words. When the user discovers that data in the real-time dictionary contain errors, it reports the errors to the server end 420 via the network.

Please refer to FIGS. 5 to 7. The real-time dictionary search interface 500 includes a reporting element 510 and search contents 520. The runs the real-time dictionary at the user end 410 to search a word. The search contents 520 are displayed in the search interface 500. When the user discovers that there is an error in the search contents 520, he or she uses the mouse cursor to enclose the error block 530, e.g., ‘Transf’. Afterwards, the user uses the mouse cursor to click the reporting element 510. The user end 410 then transmits an error message 700 to the server end 420. The error message 700 includes a user account 710 (e.g., ‘Mary24762’), a product serial number 720 (e.g., ‘D156286’), an error block location 730 (e.g., ‘8.1-C-52-2-4’), and version information 740 (e.g., ‘Version 8.1’) (step 301). The error block location 730 ‘8.1-C-52-2-4’ is the location of the error block 530 ‘Transf’.

Please refer to FIGS. 8 and 9. The server end 420 receives the error message 700 sent from the user end 410 (step 302). The server end 420 uses the error block location 730 ‘8.1-C-52-2-4’ in the error message 700 to look it up in the correspondence table of the error block locations and data indices 800. The correspondence table of the error block locations and data indices 800 includes the correspondence relations between error block location 730 and data index 810. Therefore, using the error block location 730 ‘8.1-C-52-2-4’, the corresponding data index 810 ‘81C00520204’ is found. The server end 420 further uses the data index 810 ‘81C00520204’ to search the historical data 900, which include data indices, 810, error block location 730, and reporting date 910. The server end 420 uses the data index 810 ‘81C00520204’ to check whether it already exists in the historical data 900, thereby determining whether the error message 700 is allowed. Since the server end 420 finds that the data index 810 ‘81C00520204’ does not exist in the historical data 900, the server end 420 allows the error message 700 (step 303).

Please refer to FIG. 10. The server end 420 determines whether the data index 810 ‘81C00520204’ exists in the historical data 900 (step 304). When the data index 810 ‘81C00520204’ does not exist in the historical data 900 and the error message 700 is allowed, the server end 420 saves the data index 810 ‘81C00520204’ and the corresponding error block location 730 ‘8.1-C-52-2-4’ of the error message 700 into the historical data 900 (step 305).

In should be noted that in FIG. 10, if the user at the user end 410 sends the same error block 530 (i.e., ‘Transf’) and the triggering element 510 repeats steps 301 and 302, the server end 420 uses the data index 810 ‘81C00520204’ to check the historical data 900, determining whether the data index 810 ‘81C00520204’ already exists in the historical data 900 and whether the error message 700 is allowed. Since now the data index 810 ‘81C00520204’ obtained by the server end 420 already exists in the historical data 900, the server end 420 determines not to allow the error message 700 (step 303).

Please refer to FIG. 11. The server end 420 determines whether the data index 810 ‘81C00520204’ exists in the historical data 900 (step 304). When the data index 810 ‘81C00520204’ already exists in the historical data 900 and the error message 700 is not allowed, the server end 420 returns a replying message to the user end 410 (step 306). The user end 410 displays a replying message block 540 in the real-time dictionary search interface 500, such as “This error has been processed. Thank you for the report.” To notify the user that this error has been reported before.

In summary, the invention differs from the prior art in that the user end reports an error message to the server end. The server end then looks up the historical data according to the error message to determine whether the error message has been reported before. If it has not been reported, the error message is stored in the historical data. If it has been reported, a replying message is returned. Using the above-mentioned technical means, the invention can increase the convenience in error reporting as well as the efficiency in processing the error reports.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An error reporting system for reporting errors of an application program via a network, the system comprising:
a user end, which runs the application program and, through the triggering of a reporting element, transmits an error message that contains user information and an error block location in the application program; and
a server end, which includes:
a receiving module for receiving the error message sent from the user end;
a determining module for finding a data index corresponding to the error block location of the error message and using the data index to check historical data, thereby determining whether the error message is allowed;
a storage module for storing the error block location of the error message into the historical data when the data index does not exist therein and the error message is allowed; and
a replying module for returning a replying message when the data index already exists in the historical data and the error message is not allowed.

2. The error reporting system of claim 1, wherein the user information includes at least a user account of the user and a product serial number of the application program.

3. The error reporting system of claim 1, wherein the error message further includes version and update information of the application program.

4. The error reporting system of claim 1, wherein the error block location is obtained from the user end by using a mouse cursor to enclose an error range of the application program.

5. The error reporting system of claim 1, wherein the determining module stores the correspondence relations between the error block location and the data index.

6. An error reporting method for reporting errors of an application program via a network, the method comprising the steps of:
running the application program on a user end and, through the triggering of a reporting element, transmitting an error message including user information and an error block location in the application program;
receiving at a server end the error message sent from the user end;
using the error block location of the error message to find a corresponding data index on the server end and determining whether the error message is allowed by checking historical data with the data index;
saving the error block location of the error message into the historical data when the data index does not exist therein and the server end allows the error message; and
returning a replying message when the data index already exists in the historical data and the server end does not allow the error message.

7. The error reporting method of claim 6, wherein the user information includes at least a user account of the user and a product serial number of the application program.

8. The error reporting method of claim 6, wherein the error message further includes version and update information of the application program.

9. The error reporting method of claim 6, wherein the error block location is obtained from the user end by using a mouse cursor to enclose an error range of the application program.

10. The error reporting method of claim 6, wherein the determining module stores the correspondence relations between the error block location and the data index.
